(19) United States
(12) Patent Application Publication
(10) Pub. No.: US 2013/0034873 A1
(43) Pub. Date: Feb. 7, 2013

(54) METHOD FOR THE EXTRACTION AND DETECTION OF FAT-SOLUBLE COMPONENTS FROM BIOLOGICAL MATERIALS

(71) Applicant: Florian J. Schweigert, Berlin (DE)

(72) Inventor: Florian J. Schweigert, Berlin (DE)

(21) Appl. No.: 13/497,851

(22) PCT Filed: Sep. 21, 2010
(86) PCT No.: PCT/EP2010/063855

§ 371 Date: Oct. 3, 2012

(30) Foreign Application Priority Data
Sep. 23, 2009 (EP) 09171123.4
May 3, 2010 (EP) 10161784.3

(51) Int. Cl. G01N 21/64; G01N 21/31; C12S 3/18

(52) U.S. Cl. 435/19; 435/267

(57) ABSTRACT

The present invention relates to a method for the analysis of fat-soluble components, in particular dyes, from biological materials, in particular lipid rich foodstuffs, having an enrichment of the components and subsequent analysis. The method comprises a combination of extraction and separation steps and a subsequent analysis step. The invention further relates to an analytical kit and analytical equipment for carrying out the method. The method according to the invention is composed of a plurality of steps. The critical steps which are essential and characterize the invention are: 1. Pre-treatment of the sample to remove lipids. 2. Extracting the dyes into an extraction mixture by a specific solvent or solvent mixture. 3. Destruction of the oxidative sensible ingredients such as carotenoids prior to the final detection and quantification by eye or by optical enhancement.

The present invention relates to a method for the analysis of fat-soluble components, in particular dyes, from biological materials, in particular lipid and pigment rich foodstuffs, having an enrichment of the components and subsequent analysis. The method comprises a combination of extraction,separation and destruction steps and a subsequent analysis step.

The invention further relates to an analytical kit and analytical equipment for carrying out the method.

The method according to the invention is composed of a plurality of steps. The critical steps which are essential and characterize the invention are:
1. Pre-treatment of the sample to remove lipids.
2. Extracting the dyes into an extraction mixture by a specific solvent or solvent mixture.
3. Destruction of the oxidative sensible ingredients such as carotenoids prior to the final detection and quantification by eye or by optical enhancement.

In the foreground of the invention are the dissolution of the complex compound between the fat-soluble components and the biological matrix, provision of analytical kits and the use of the method for determining the substances which are hereinafter also called components in food and feeds.

Fat-soluble components which come into consideration for the detection method according to the invention are dyes. Natural and synthetic dyes are used for dyeing products of varying application. They serve for imparting certain optical quality features. Biological materials which can be dyed are egg yolks and egg products, spices, spice mixtures and spice preparations in solid pasty or liquid form, meat and meat products, fish and fish products, fruit and vegetable juices and/or preparations and also butter or other milk products. The dyeing of biological materials which are used for human consumption can be introduced either via the feed or in the processing.

Increased requirements of the safety of foods and feeds and also for the detection of toxic substances or falsifying substances, especially in international trade of goods, require rapid, sensitive and reliable analyses, preferably as close as possible to the product. Therefore, methods which consist of as few working steps as possible and/or have little technical complexity are required. In this case the use of methods which can be applied on the basis of disposable analytical kits is desirable.

In this context there is, for example, the detection of color falsification of foods and feeds with Sudan Red or other dyes.

Modern methods for the analysis of biological materials frequently comprise steps for separation, extraction, isolation and/or enrichment of constituents and also components of the biological materials. Such method steps are indispensable both in qualitative and quantitative analysis for separating off substances which interfere or which falsify results.

WO 2008/031874 discloses a method for analyzing constituents, in particular carotenoids and vitamins, of biological materials, which is characterized in that the biological material is treated with at least one organic solvent which extracts the constituent followed by analytical measurerment of the extracted solution by spectrophotometry.

Starting from WO2008/031874, the purpose of the present invention is to provide a method for the extraction of natural and synthetic dyes, especially Sudan dyes, from lipid rich biological material, which method is selective enough to dissolve the substances with comparatively little complexity from the biological material, for example a complex solid matrix, and if required can be applied simply and rapidly by means of a disposable analytical kit.

This purpose is achieved by the method as claimed in claim 1, the use as claimed in claim 16 and analytical kits as claimed in claim 17.

Preferred embodiments are described in the dependent claims. The wording of all claims is hereby incorporated in this description by reference.

Pretreatment, extraction and any subsequent separation are combined according to the invention in such a manner that the dyes can be detected in a very small amount.

In the context of the present invention, “biological materials” are taken to mean food and feed obtained from plants or animals which are rich in lipids, such as egg, butter, fatty milk, cheese, sausages, oils or other materials such as spices and mixtures of spices.

In a preferred embodiment of the method, the biological materials, before their use, are subjected to mechanical disruptions and purification processes.

It is further advantageous that the extraction is carried out manually by shaking, in particular careful shaking avoiding hemolysis.

Problems which had to be solved in accordance with the present invention are the following:

Firstly, using the method described in WO2008/031874, the lipids (fat) of the biological material would extract into organic phase together with the dyes. This extraction of fat would disturb the separation and the detection limit would increase drastically. Therefore, the extraction of fat should be reduced or removed as complete as possible.

One possible solution would be to find a specific water buffer/org. solvent combination which allows selective extraction of dyes but not fat. Experiments on this way resulted in a separation solvents system, allowing the selective extraction of the sudans (I, II, III, IV) and some carotenoids, but little fat.

Another possible solution would be to use a chemical treatment of fat rich material (eg. egg yolk) prior to extraction in order to convert fat to a non-extractable form or to destroy it. For example, treatment with water/alcoholic KOH will convert the fat into potassium salts of fatty acids and glycerol.

A third possible solution, which is the preferred one, is to use at least one lipase for enzymatic digestion of fat prior to extraction, which will lead to the same result as chemical treatment but in mild and safe conditions and also faster.

In this context, a lipase is an enzyme that catalyzes the hydrolysis of ester bonds in triglyceride substrates found in oils and fats from biological material leading to mono and diglycerides and free fatty acids. The lipases of the invention may furthermore be capable of degrading dietary lipids (e.g. triglycerides, fats, oils) which are rich in C₈ to C₁₈ fatty acids with high substrate specificity.

Secondly, oxidative destruction of carotenoids is necessary in order to determine dyes in biological material. This is necessary, because dyes and carotenoids behave very similar with regard to their separation behaviour eg during chromatographic separation steps or with regard to their spectral characteristics.

Carotenoids are poly-unsaturated long chain hydrocarbons with conjugated double bonds, and their derivatives. Due to such a structure they are easily undergo oxidation e.g. with air oxygen or other mild oxidizers like peroxides. When conjugated system of double bonds is destroyed, light absorption decreases and its maximum shifts in wavelength into shorter area. Observed effect is disappearing of characteristic yellow-orange color. Oxidation occurs with different speed depending on oxidizer, media, concentrations of carotenoids and oxidizer, concentration of other reactive substances which may interfere with the oxidizer.

The dyes such as Sudans in contrast are much more stable to oxidation processes. Therefore, the treatment of samples with oxidizing an agent only affects the carotenoids and not the Sudan dyes.

As an oxidizer, the peroxy compounds are preferred. Peroxides in the concentrations used oxidize efficiently carotenoids but not the sudans. They are easily available in both water soluble form (inorganic peroxides, such as H₂O₂, K₂S₂O₈) and in organic soluble (benzoyl peroxide), which makes easy to perform experiments.

The oxidizing of carotenoids in whole egg yolk prior to lipase treatment is problematic on two reasons. First, it requires much more oxidizer to be mixed in to reach the working concentration. This is due to large sample volume and an excess of the side compounds which are also undergo oxidation. Secondly, the excess of oxidizer must be removed or neutralized before the enzyme is added, otherwise enzyme will be destroyed as well.

Oxidizing after treatment prior to extraction is also not practical. The urea-containing buffer is stabilizing peroxide which result in reaction slow down even by high concentration of peroxide.

Most practical is to perform bleaching of carotenoids after the extraction. In this case the quantity of peroxide could be decreased due to it consumption only by carotenoids. Most of other oxidizable substances are left in lower (water-containing) buffer.

Oxidation can be performed within the organic solvent in which the carotenoids and sudan dyes are extracted prior to separation (solvent-phase bleaching), or the oxidizing material can be integrated into the column material and carotenoids are destroyed during separation within the column (column-phase separation) and finally carotenoids can be destroyed through oxidation after separation e.g. on TLC placates (post-run bleaching).

The oxidative destruction of the less stable carotenoids can be enhanced or speed up by the combination with Uv illumination. In general any UV light that causes or enhances the diostriction of liable components can be used.

Most favourable is UV light below 400 nm wavelength. Usually wavelength below 350 nm best in the range below 300 nm can be used. The UV light can be applied through conventional UV lamps, UV light emitting diodes (LED) or by using appropriate UV laser diodes Alternatively the natural UV light can be used if exposed appropriately to the sun.

This UV enhancement can be applied in all steps either pre-colume treatment or on-colume during column separation.

In a preferred embodiment of the invention, it is convenient to combine the carotenoids bleaching with a specific separation step, which follows after extraction but prior to the final detection (column-phase bleaching), thus saving time of the analysis. By this reason applicant has chosen to immobilize the peroxide onto separation sorbent.

The result is that when separation is complete, only one red band of sudan appears on the micro-column (in case sudan is present in the sample). The detection limit in this approach is estimated to be 0.5-1 ppm sudan in initial egg yolk.

In another preferred embodiment of the invention, it is convenient to enhance the oxidative bleaching after extraction of carotenoids from the matrix. The degradation is enhanced and accelerated by the simultaneous application of UV-light in a range of 340-280 nm for a period of 5-30 minutes. The application time depend on the amount of carotenoids present in the extract. The higher the carotenoid content, the longer the exposure necessary. At concentrations of 20 ppm 5-10 minutes are used, at 60 ppm 10-20 minutes and at 90-100 ppm 20-30 minutes are applied. However, the time necessary is dependent on the intensity of the light and has to be adjusted appropriately.

In the following the different process steps, the analytical kit and the analytical equipment for carrying out the method are described in more detail.

1. Pre-Treatment

The purpose of adding a dilution solution during sample preparation is not only dilution of the sample, but especially preparation for the extraction by dissolution or solubilization of the complex matrix. Optimally, the dilution solution modifies the sample in such a manner that components can be extracted more easily, in a targeted manner and more completely. In this process, for example protein interactions with the components of the dilution solution play a role. This action is based either on a general increase of ionic concentration compared with pure water or the introduction of specific components which react with components of the matrix. This relates to the dissolving of disulfide bonds, the unfolding of proteins by strongly hygroscopic molecules or the interaction with phosphate groups. The dissolution of complex chemical structures by enzymes is also possible in the context of the inventive step.

It has been found that a pretreatment with certain salt solutions or buffer solutions, in particular with differing concentrations of urea solutions, leads to a marked improvement of the complex structures of a biological matrix and thereby a more efficient extraction.

An addition of water-soluble organic components, detergents, surfactants, in particular nonionic surfactants or emulsifiers, can also promote extraction efficiency. Additives which come into consideration are, for example, DMSO or DTT. Alternatively surfactants and detergents are eg pleuronic, Tween.

When urea is used in a concentration range from 0.1 to 8 M, preferably 1 to 8 M, and especially 2 to 4 M, in the case of biological materials such as eggs, fish muscles or liver, either only a simple shaking or the use of a hand mixer of the speed of rotation and power development of a milk foamer is sufficient. As a result, complex extraction methods can be markedly improved and facilitated.

Owing to different physicochemical properties of fat-soluble components and the great differences in the matrix of the biological sample, the respective composition of a solvent for dissolution of the sample matrix is of great importance for subsequent extraction.

Further solvents for sample preparation and/or sample dilution may be described and/or defined as follows depending on the biological material used:

Buffers, in the context of the present invention, comprise a buffer solution and/or a buffer system, i.e. a mixture of substances, the pH of which (concentration of hydrogen ions), on addition of an acid or base, changes significantly less than would be the case in a unbuffered system. Such buffer solutions contain a mixture of a weak acid and its conjugate base (or of the respective salt).

Ampholytes and bifunctional molecules can also act as buffers. The factor determining the pH is the ratio or protolysis equilibrium of the buffer pair.

Examples of buffer solutions are: acetic acid/acetate buffer, phosphate buffer KH₂PO₄+Na₂HPO_{4;} veronal-acetate buffer of Michaelis; ammonia buffer NH₃+H₂O+NH₄Cl; HEPES (4-(2-hydroxyethyl)-1-piperazinethanesulfonic acid) PBS buffer; MES (2-(N-morpholino)ethanesulfonic acid).

Salt solutions are solutions of salts which are made up of positively charged ions, called cations, and negatively charged ions, called anions. Salts can be of organic or inorganic nature. In the narrowest sense salt is taken to mean sodium chloride (NaCl, common salt). In the broad sense, all compounds are called salts that are made up, like NaCl, of anions and cations.

Salts are termed complex salts where independent (stable) ions are present with the interaction of molecules.

In addition to salts having one type of cations, salts having two different cations are also known. These salts are termed double salts, such as alauns having the general composition M^{I}M^{III}(SO₄)₂. One example is aluminum potassium sulfate dodecahydrate (KAI(SO₄)₂.12H₂O).

In addition to the inorganic salts described, there are also salts of organic compounds. The anions of these salts originate from organic acids. Of importance here are the salts of carboxylic acids such as, for example, acetic acid, of which many salts, called acetates (CH₃COO⁻), are known. Examples are the salts sodium citrate and calcium citrate.

Organic compounds which perform a dissolution of complex matrices” in the context of the present invention include, for example, urea. Urea originates from protein and amino acid metabolism of humans and animals. Urea, because of its high water binding capacity, is used as a keratolytic which dissolves complex matrices. It is added to foods as a stabilizer. In the EU, as a food additive with the designation E 927b, it is permitted solely for chewing gum without sugar addition.

According to the invention, the sample of the biological material is treated with at least one lipase for enzymatic digestion of lipids prior to extraction.

In a particular embodiment, the lipase, in the form in which it is added to the sample is well-defined. Well-defined means, that the lipase preparation is at least 50% pure on a protein-basis. In other particular embodiments the lipase preparation is at least 60, 70, 80, 85, 88, 90, 92, 94, or at least 95% pure. Purity may be determined by any method known in the art, e.g. by SDS-PAGE, or by Size-exclusion.

In the present context, a lipase means a carboxylic ester hydrolase EC 3.1.1.-, which includes activities such as EC 3.1.1.3 triacylglycerol lipase, EC 3.1.1.4 phospholipase A1, EC 3.1.1.5 lysophospholipase, EC 3.1.1.26 galactolipase, EC 3.1.1.32 phospholipase A1, EC 3.1.1.73 feruloyl esterase. The EC number refers to Enzyme Nomenclature 1992 from NC-IUBMB, Academic Press, San Diego, Calif., including supplements 1-5 published in Eur. J. Biochem. 1994, 223, 1-5; Eur. J. Biochem. 1995, 232, 1-6; Eur. J. Biochem. 1996, 237, 1-5; Eur. J. Biochem. 1997, 250, 1-6; and Eur. J. Biochem. 1999, 264, 610-650; respectively. The nomenclature is regularly supplemented and updated; see e.g. the World Wide Web at http://www.chem.qmw.ac.uk/iubmb/enzyme/index.html.

In a preferred embodiment, the lipase of the invention is a pancreas lipase or Piccantase, or a phospholipase.

2. Extraction and Separation Step

As organic solvents for extraction and if necessary subsequent analysis, use is made of polar protic solvents, in particular alcohols.

In a further preferred embodiment of the method, use is made of the polar protic solvents selected from the group consisting of methanol, ethanol, 1-propanol, 2-propanol (isopropanol), butanol, pentanol, hexanol and also mixtures thereof. Preferably, use is made here of mixtures of ethanol and/or DMSO).

In a further preferred embodiment of the method, as organic solvent, use is made of at least one polar aprotic solvent, in particular esters, preferably ethyl acetate.

Advantageously, in the method according to the invention, in addition to the preferred polar protic solvents, use may also be made of polar aprotic solvents.

In a further embodiment of the invention, as polar aprotic solvents, use is made of nitriles, preferably acetonitrile.

In a further embodiment of the method, as polar aprotic solvents, use is made of ketones, preferably acetone.

In a further embodiment of the method, as polar aprotic solvents, use is made of dimethyl sulfoxide and/or N,N-dimethylformamide.

In a further embodiment of the method, as polar aprotic solvents, use is made of ethers, in particular diethyl ether.

Preferably, the polar solvents are used in the form of mixtures depending on the biological materials.

In a further preferred embodiment of the extraction step, as solvents, use is made of at least one nonpolar solvent, in particular alkanes, preferably C5 to C12 alkanes.

In a further preferred embodiment of the extraction step, as nonpolar solvent, use is made of hexane, heptane and/or octane, in particular isooctane

In a further embodiment of the extraction step, as nonpolar solvents, use is made of aromatics, in particular toluene and/or benzene.

Said nonpolar solvents act in the method according to the invention as extraction media for the components, in particular for the lipophilic components.

According to the invention it can be expedient to use derivatives of organic solvent molecules.

The solvents can be anhydrous, water-containing, branched, unbranched, cyclic, acyclic, halogenated or nonhalogenated.

Division into polar or nonpolar solvents can be performed in industry from various aspects. For example, definitions of polarity or solvent behavior known from chemistry can be used.

In addition, a polarity index according to Snyder or Keller is used in practice (Synder, Principles of absorption chromatography, Decker, N.Y., 1968; Keller, Analytical chemistry, Weinheim, 1998, page 195), for classifying solvents or solvent mixtures. According to this, polar solvents or solvent mixtures are taken to mean a solvent or solvent mixture having a polarity index of 4 to 8, in particular 5 to 7, preferably 5.5 to 6.5, according to Snyder. Polar solvents are, for example, water, in particular aqueous solutions. Polar aprotic solvents are, for example, acetone, acetonitrile, ethyl acetate, dimethyl sulfoxide or N,N-dimethylformamide. Polar protic solvents are, for example, alcohols which comprise an alkyl moiety having 1 to 6 carbon atoms, for example methanol, ethanol, 1-propanol, 2-propanol (isopropanol), butanol, pentanol or hexanol.

A nonpolar solvent or nonpolar solvent mixture is taken to mean a solvent or solvent mixture which, in comparison with a reference solvent or reference solvent mixture, has a polarity index which is 0.3 or more lower. Preference is given to a polarity index which is 0.5 lower, in particular a polarity index 1 lower, preferably a polarity index lower by more than 2. Consequently, the polarity index of the nonpolar solvent or solvent mixture has a value of 5 to 1, in particular 4 to 2, preferably 3.5 to 2.5, according to Snyder. A solvent mixture of 60% methanol/40% dichloromethane has, for example, a polarity index of 3.1 according to Snyder. Nonpolar solvents which consequently come into consideration are, for example, halogenated solvents such as chloroform, dichloromethane or carbon tetrachloride. In addition, aliphatic solvents such as pentane, hexane, heptane or cyclohexane may be mentioned. In addition, nonpolar solvents which may be mentioned are aromatic solvents such as toluene or benzene. Furthermore, ethers such as diethyl ether, tert-butyl methyl ether or tetrahydrofuran come into consideration.

In a further preferred embodiment of the method according to the invention, the solvents of the extraction step are used in the form of solvent mixtures, in particular in the form of solvent mixtures which comprise polar and nonpolar solvents.

Preferably, the polar and nonpolar solvents are used in a ratio of 10:1 or 3:1, in particular in a ratio of 1:1 or 1:2, preferably in a ratio of 1:10 (polar:nonpolar).

This measure has the advantage that solvent mixtures can be produced which are matched according to the properties of the biological materials. In this manner, a multiplicity of separation problems can be handled.

In a further preferred embodiment, the biological materials are treated with the organic solvent mixture in a ratio of 1:50, in particular in a ratio of 1:10, preferably in a ratio of 1:3 or in a ratio of 1:2.

Depending on the properties of the biological materials and extraction capacity of the organic solvents, it can be expedient to select a greater or lesser ratio of biological materials to organic solvents, and in particular this depends on the subsequent analysis. Preferably, the ratio is selected in such a manner that the detection limit or limit of determination in the analysis of the components is taken into account.

In a further embodiment, the method is carried out at a pressure between 0.5 bar and 5 bar, in particular between 0.8 bar and 2 bar.

In theory the method may be carried out in temperature and/or pressure ranges at which gel formation may be expected. In addition, solvent properties, in particular melting point, boiling point, flash point must be taken into account. According to the invention the method is carried out at room temperature and atmospheric pressure.

In a further preferred embodiment of the method, the biological materials are treated for extraction of the components for a time period of from 10 seconds to 10 minutes, in particular from 10 seconds to 5 minutes, preferably from 10 seconds to 3 minutes.

Preferably, the samples are pretreated with a dilution buffer before the extraction. The dilution ratio is between 1:9 (buffer:sample) and 100:1, in particular 1:1 to 50:1, preferably 10:1.

Preferably, the biological materials are transferred into a solvent-resistant environment before the treatment with the organic solvents.

In a further embodiment, as solvent-resistant surrounds, use is made of a vessel having a hydrophobic surface, in particular a vessel having a surface which is hydrophobized by silanization.

In a further embodiment, use is made of a vessel having a hydrophobic surface, in particular a plastic vessel, preferably made of polypropylene.

Advantageously, in the method according to the invention, vessels having hydrophobic surfaces can be used. The hydrophobic surfaces, in the case of glass vessels, may be produced by silanizing the glass surface or by etching it with hydrogen fluoride. In addition, plastic vessels, preferably made of polypropylene, can also be used in the method according to the invention. A use of composite materials for the vessels, in particular plastic-coated vessels, is also possible. Preferably, use is made of vessels which are of a nature such that they are suitable for spectroscopic examinations.

In a preferred embodiment of the invention an enrichment and separation step is applied, for example by chromatographic methods, which are subsequent to the extraction. A miniaturized chromatographic method is preferred. It can be expedient to select the composition of the extraction solvents in such a manner that no mixture and/or complete separation of, for example, alcohols and organic solvents, occurs. A suitable solvent here is preferably DMSO (dimethyl sulfoxide) as aprotic dipolar solvent and n-hexane or isooctane. In this case the nonpolar solvent can also be added to the processing buffer. As a result the solvent which is extracting can equally be used as mobile solvent for the subsequent chromatographic enrichment and separation. In a further embodiment, the method is carried out at a temperature in the range from 5° C. to 60° C., in particular in the range from 10° C. to 40° C.

In the preferred embodiment, enrichment and separation proceed on the stationary phase via the same solvent or solvent mixture which was used for the extraction. However, a stepwise enrichment and separation is also possible using different solvents or solvent mixtures.

In the preferred embodiment, the lipophilic components which are to be separated and examined, are, after the extraction step, already in the mobile phase. The enrichment and/or separation proceeds by means of a stationary phase in chromatographic systems. Chromatographic systems which come into consideration are thin layer chromatography or column chromatographic systems. Stationary phases which come into consideration are silica gel, cellulose, cyclodextrin, aluminum oxide, florisil and other substances which, owing to their physicochemical properties, are suitable for the respective component. The selection of mobile and stationary phases depends on the separation problem. The materials can, in addition, be modified in their surface properties by targeted chemical modifications. As an example of the chromatography of lipids, the surface treatment of silica gels with silver ions may be mentioned. However other methods can also be suitable.

In addition to the use of uniform stationary phases, stationary phases can also be combined. This combination can proceed either by mixing a plurality of different phases or by a layerwise structure of the column packing. By means of the layerwise structure, various separation and enrichment effects can be achieved.

In accordance with the present invention, oxidative destruction of carotenoids is necessary, wherein as an oxidizer, peroxy compounds are preferred.

The pressure buildup for the flow of the mobile phase can be generated either via gravity or via other methods by which a low pressure causes the mobile phase to run.

In the preferred embodiment, the flow of the mobile phase is generated by the one opening of a miniaturized column packed with the stationary phase being brought into the closed extraction unit. This proceeds by penetration of a rubber septum or a septum of another kind. The depth of the penetration has to be defined to avoid contamination with the non-polar solvent at the bottom of the extraction vial and to standardize the volume of organic solvent to be able to run through the column. This can be achieved either by a spacer on the column that defines the depth of penetration of the column into the extraction tube. Other options are specific individual holder of the capillary or a rack for a specific number of samples to be treated the same time. A combination of both options is also possible. The individual holder for the capillary can serve as well as waste reservoir. As a result of the fixed insertion of the capillary, at constant sample volume and constant solvent volume it can be ensured that the opening of the column is in the organic extraction medium and that only a defined amount of solvent is used.

The pressure for the flow of the solvent is built up by piercing using a syringe via a needle next to the chromatography tube and pumping in about 10 ml of air via the syringe. This volume is dependent on the size of the extraction tube and the volume of the solvent. By means of the overpressure which is created, flow of the mobile phase occurs.

A further empty extraction tube is stationed on the opposite side, in which extraction tube the mobile phase is collected. As a result no fouling of the working place occurs. The rubber septum which is likewise present closes after removal of the chromatographic column and both units can be disposed of without the examiner coming into contact with the chemicals. In the preferred embodiment, this is achieved by the integration of the capillary in a disposable reservoir which also functions as a spacer for the fixation of the capillary in the right position and distance.

Identification of the enriched and/or separated dyes proceeds either directly by eye or by spectroscopic methods if substances having a characteristic inherent color are concerned; or by means of fluorescence if the substances have characteristic excitation and emission spectra.

In a preferred embodiment of the invention, the oxidizer is immobilized onto a separation sorbent, as for example benzoyl peroxide which allows carotenoid bleaching after extraction but prior to the final detection.

3. Analytical Step

The invention further relates to methods of analyzing the extracted components. For analysis of the components, all known analytical techniques or else analytical techniques which are unknown to date come into consideration. Separation of the components, for example by chromatographic methods, in particular by high performance liquid chromatography (HPLC) can prove to be required for further analysis. Expediently, the supernatant is supplied to analytical methods which examine the components spectrometrically. Spectrometric methods which come into consideration are those which examine the components by an interaction with electromagnetic radiation, in particular NMR, IR, UV-VIS, laser-Raman spectroscopy.

A preferred embodiment of the analysis proceeds via a spectrophotometer. Particular preference is given to a handleable transportable instrument with which the photometric measurement can be carried out rapidly and reliably.

4. Analytical Kit and Analytical Equipment

The invention further relates to analytical units containing organic solvents or solvent mixtures and the use thereof for the direct analysis of extracted substances.

Particularly preferred analytical units consist of two separate analytical kits, namely a pretreatment kit and an extraction kit, with which the method according to the invention can be carried out in two steps. For instance the biological material is disrupted and diluted in a pretreatment kit. Subsequently a liquid sample is transferred from the pretreatment kit into an extraction kit in which the substance is then extracted, transferred to the organic phase and measured directly with the spectrophotometer. Alternatively the organic phase can be transferred into another unit where it is treated to remove the carotenoids and measured directely therafter.

Both kits are formed in this case, for example, by one vessel each which is formed of plastic or glass and which contains the buffer medium and/or solvent dependent on the biological material and the substance to be analyzed.

Depending on the properties of the components, the latter can be further worked up before analysis, for example by enrichment and/or separation on miniaturized capillaries which are packed with separation materials.

In a further preferred embodiment of the analytical method, the components dissolved in the organic solvent are directly enriched and simultaneously separated. The separation can be performed using complex chromatographic methods such as HPLC or gas chromatography, or via standard or miniaturized column chromatography or thin-layer chromatography. In the preferred embodiment, the components are enriched directly from the extraction unit under pressure on a miniaturized chromatography column and separated from interfering substances. The enrichment and separation is an absorption method. In this case the substances are retained on the stationary phase by Van der Waals' forces, dipole-dipole interactions or hydrogen bonds.

The invention is described based on different results given in the following examples and figures.

FIG. 1: Effect of graded DMSO concentrations (in % of total volume) and different concentrations of urea (in molar concentration) in the buffer on the extraction efficacy of carotenoids and sudan from egg yolk samples.

FIG. 2: Comparison of the standard extraction procedure for egg yolk with the effect of graded concentration of DMSO.

FIG. 3: Effect of the digestion of egg yolk lipids by lipases prior to separation of carotenoids and sudans on miniature column chromatography.

FIG. 4 left: Effect of the lack of lipid digestion on carotenoids and sudan separation on TLC. FIG. 4 right: Effect of the digestion of lipids prior to carotenoids and sudan separation on TLC.

FIG. 5. Effect of different lipases on the liberation of free fatty acids from egg yolk lipids.

FIG. 6a: Effect of solvent phase bleaching with peroxide on the removal of carotenoids as determined by HPLC.

FIG. 6b: Decrease in total carotenoids by UV illumination

FIG. 7: Effect of column phase bleaching with peroxide on the removal of carotenoids in miniaturized columns.

FIG. 8: Effect of post-run bleaching with peroxide on the removal of carotenoids on TLC plates.

### DESCRIPTION OF FIGURES

FIG. 1 shows a diagram of 5 different data sets. Each one is characterized by a different concentration of urea in the extraction medium. Additionally, at each urea the amount of DMSO was varied from 0 to 100%. It clearly shows, that with increasing concentration of DMSO the extraction efficacy is significantly increased. Values between 50 and 75% can be regarded as optimal,

FIG. 2 shows a similar experiment but in this case the concentration of urea was kept constant at 1 M. The data are presented as percentage of the maximal extraction of carotenoids and sudan from egg yolk if a solvent mixture of isopropanol:ethanol:n-hexane (1:2:6) is used (group 6). Individual composition of the media has been:

1=Water ((Dilution solution); n-Hexane (extraction medium)

2=10% DMSO+1 M Urea (Dilution solution); n-Hexan (extraction medium)

3=25% DMSO+1 M Urea (Dilution solution; n-Hexan (extraction medium)

4=50% DMSO+1 M Urea (Dilution solution; n-Hexan (extraction medium)

5=75% DMSO+1 M Urea (Dilution solution; n-Hexan (extraction medium)

6=1 M Urea (Dilution solution; Ethanol:iso-Propanol:n-Hexan (V:V:V 1:2:6) (extraction medium)

FIG. 3 shows the effect of lipase on the separation power of carotenoids and sudan in miniaturized columns. In this case egg yolk samples were incubated with lipase (Picantase) with increasing concentrations of 1.5 to 100 mg/ml sample. When band sharpness is taken as a criterium, lipase concentration of 12 to 25 mg/ml are optimal.

FIG. 4 shows the effect of lipase treatment on the separation efficacy of carotenoids and sudan on TLC. TLC plates were Merck 1.05583. Eluent was 10% acetone in n-hexane. On the left side no lipase treatment resulted in heavily distorted bands while on the right hand the bands are clean and sharp.

FIG. 5 shows the effect of lipase treatment on lipid digestion in egg yolk as a factor of time. Egg yolk samples were incubated with three different lipases at similar concentrations (50 mg/ml). Degration of lipids is measured as release of free fatty acids. The final point was taken as 100%. Data show ale three lipase to be able to digest lipids at 25° C. efficiently. Using lipase R8000 gave the best results after 60 minutes.

FIG. 6 shows the results of a solvent-phase bleaching on the removal of carotenoids from egg yolk extracts spiked with the indicated carotenoids. In this experiment peroxide was added to the organic extract (iso-octane) prior to separation. The degradation of individual carotenoids was determined by HPLC at the indicated point of time. Results show, that within 60 minutes carotenoids are completely destroyed by peroxide. The spiked sudan level, however, was not affected.

FIG. 7 shows the effect of column-phase bleaching on the removal of carotenoids within the miniaturized column. In this case the column is filled with peroxide impregnated material. Egg yolk carotenoids and spiked sudan dyes are extracted into iso-octane after lipid digestion with Piccantase A. The extract is separated on the column. Results show that carotenoids are completely destroyed by oxidation during the run through the column.

FIG. 8 shows the effect of post-run bleaching on the degradation of carotenoids. Carotenoids and spiked sudan were extracted from egg yolk as in FIG. 8 and then applied to TLC and developed as described in FIG. 4. Thereafter, TLC plates are sprayed with peroxide in n-hexane. Results show that carotenoids are completely removed within a few minutes after peroxide treatment.

### EXAMPLE 1

### General Extraction and Determination of Sudan Red from Egg Yolk

For improving the yellow coloring and for increasing the color stability, dyes are added to various naturally yellow or red colored foods. Whereas the natural or nature-identical carotenoids are safe, when azo compounds are added there is a high level of health risks. For this reason their addition is forbidden and products which contain these artificial colors must be removed from the market. Rapid reliable and sensitive detection is necessary for this purpose.

Examples of such a method are described hereinafter for egg yolk.

A large fraction of egg yolk consists of lipids. Coloring components are the carotenoids. In eggs the carotenoids lutein, zeaxanthin β-carotene and canthaxanthin are found in differing relationships to one another. They pass into the egg yolk via the feed. To intensify the coloring, the feeding of synthetic dyes of the group of azo compounds is performed. An important representative is Sudan III (red).

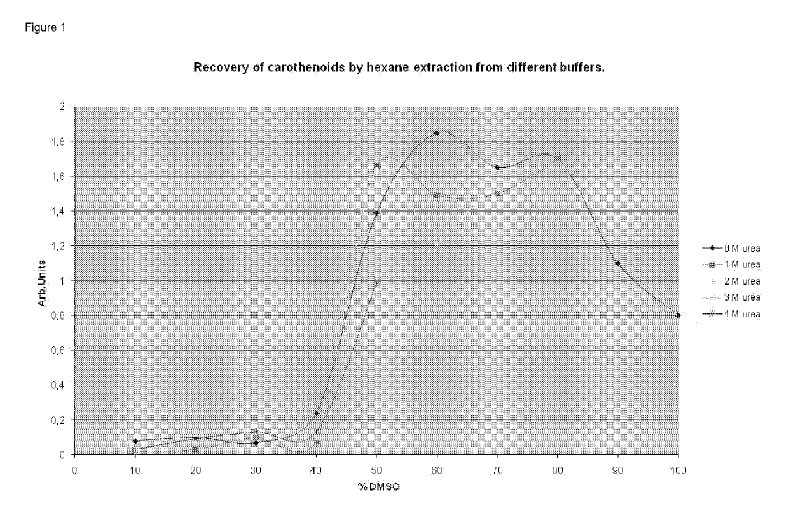

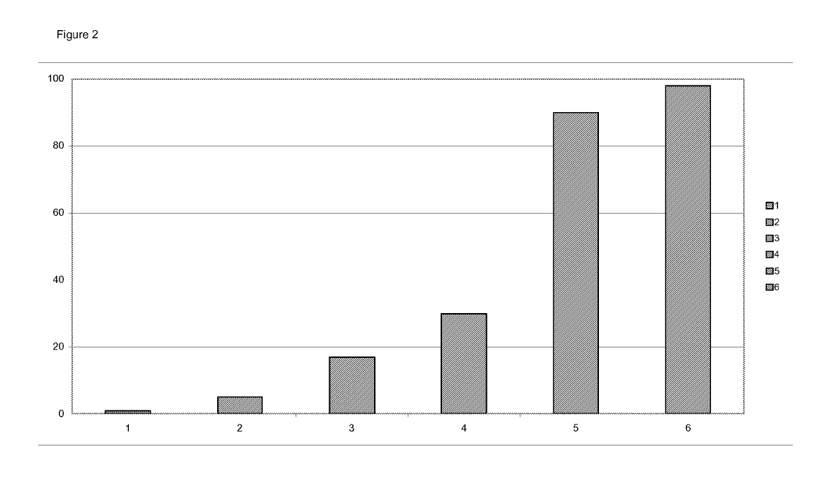

The following example demonstrates the steps for extraction and detection of carotenoids and Sudan Red from egg yolks. The importance of sufficiently high concentrated DMSO is shown in FIGS. 1 and 2.

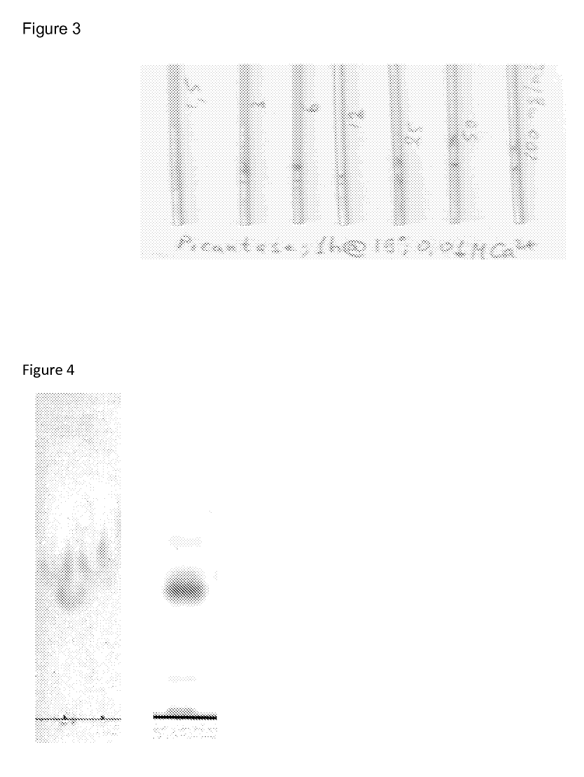

In each case 1 gm of egg yolks were mixed with 4-10 times the volume of a buffer solution or distilled water and subsequently isolated in a single step in a single-phase solvent or solvent mixture. The carotenoids were determined in the organic extract either by means of HPLC or spectroscopy. Vitamins A and E were determined by means of HPLC.
a) Mixing of 1 g of egg yolk with in each case 4 ml of diluent, either distilled water or buffer solution (eg. 0.1 M ammonium citrate buffer). Intense manual or mechanical mixing.
b) Takeup of the mixture (generally 200 to 400 μl) in a syringe and injection into a special extraction unit via a rubber septum. The extraction unit contains a solvent (n-hexane or iso-octane) or a single-phase solvent mixture.
c) In a further step the extraction is facilitated by the addition of a mixture of buffer with DMSO and SDS (eg DMSO:4 M urea in 0.% SDS in a 5:2 ratio)
d) Extraction of the fat-soluble components into the organic extraction medium by intense shaking.
e) Separation of the phases by gravity for 3 minutes.
f) Optimization of the phase separation can be achieved by addition of a highly concentrated salt or buffer solution in a volume of preferably 500 μl.
g) Measurement of the supernatant directly in the spectrophotometer.
h) Alternatively takeoff of the solvent supernatant and measuring the components by mexans of HPLC or spectrophotometry. Vitamins A and E were determined by means of HPLC.
i) For enrichment and separation, the extraction is followed by column-chromatographic separation. For this purpose a miniaturized chromatography column packed with silica gel (stationary phase) is brought into the extraction tube. For this the rubber septum of the extraction unit is penetrated and the lower introduced end of the column positioned in such a manner that it is just above the aqueous phase. On the opposite side of the column the collecting unit is mounted.
j) By means of a syringe of 5-10 ml volume, via a needle, air is pumped via the septum into the extraction unit for approximately 10 min. An overpressure is formed which leads to the organic extraction medium flowing from the extraction unit via the chromatography column (stationary phase silica gel) into the collecting unit. In this process enrichment and separation of the carotenoids and of Sudan Red occurs.
k) Semiquantitative estimation of the concentration proceeds via comparison of the column containing the sample with columns which have a known concentration of Sudan Red.
l) Detection is performed by eye or by digital amplification of the optical signals. Carotenoids and Sudan Red are situated in separate bands (FIG. 3).

### EXAMPLE 2

### Extraction and Determination of Sudan Red from Egg Yolk According to the Invention. Improvement of Separation on Chromatographic Medium by Lipase Pretreartment

In this experiment egg samples containing natural carotenoids and spiked with different synthetic sudan dyes were treated with lipase to show the efficacy based on the determination on separation efficacy on TLC (FIG. 4) and miniaturized column chromatography (FIG. 3.
a) Mixing of 1 g of egg yolk with in each case 4 ml of diluent, either distilled water or buffer solution (eg. 0.1 M ammonium citrate buffer). Intense manual or mechanical mixing.
b) Of this mixture 200 ml are incubated with a lipase solution (Picantase A, Picantase R8000 or pancreatic lipase 200 mg/ml in 0.1 M ammonium citrate buffer). Incubation for different periods of time at RT. Incubation time can be decreased if incubation temperature is increased (eg 40 C).
c) Takeup of the mixture (generally 200 to 400 μl) in a syringe and injection into a special extraction unit via a rubber septum. The extraction unit contains a solvent (n-hexane or iso-octane or a single-phase solvent mixture.
d) In a further step the extraction is facilitated by the addition of a mixture of buffer with DMSO and SDS (eg DMSO:4 M urea in 0.1% SDS in a 5:2 ratio)
e) Extraction of the fat-soluble components into the organic extraction medium by intense shaking.
f) Separation of the phases by gravity for 3 minutes.
g) Optimization of the phase separation can be improved and facilitated by addition of a highly concentrated salt or buffer solution in a volume of preferably 500 μl.
h) The positive influence of lipase activity is determined by evaluating separation on TLC or miniaturized columns.

### EXAMPLE 3

### Effect of Lipase Treatment on the Release of Free Fatty Acids

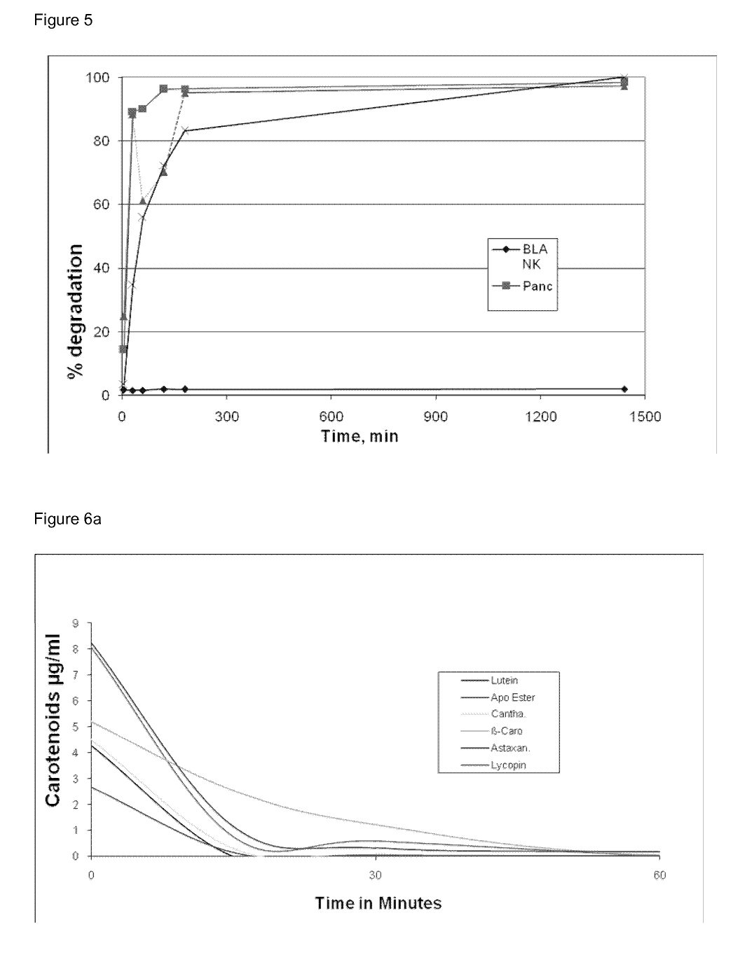

In this experiment egg samples containing natural carotenoids and spiked with different synthetic sudan dyes were treated with different lipases to show the efficacy based on the measurement of the lipase induced release of free fatty acids from the breakdown of triglycerides and other lipids (FIG. 5).
a) Mixing of 1 g of egg yolk with in each case 4 ml of diluent, either distilled water or buffer solution (eg. 0.1 M ammonium citrate buffer). Intense manual or mechanical mixing.
b) Of this mixture 200 ml are incubated with a lipase solution (Picantase A, Picantase R8000 or pancreatic lipase 200 mg/ml in 0.1 M ammonium citrate buffer). Incubation for different periods of time at RT. Incubation time can be decreased if incubation temperature is increased (eg 40 C).
c) Takeup of the mixture (generally 200 to 400 μl) in a syringe and injection into a special extraction unit via a rubber septum. The extraction unit contains a solvent (n-hexane or iso-octane or a single-phase solvent mixture.
d) In a further step the extraction is facilitated by the addition of a mixture of buffer with DMSO and SDS (eg DMSO:4 M urea in 0.1% SDS in a 5:2 ratio)
e) Extraction of the fat-soluble components into the organic extraction medium by intense shaking.
f) Separation of the phases by gravity for 3 minutes.
g) Optimization of the phase separation can be improved and facilitated by addition of a highly concentrated salt or buffer solution in a volume of preferably 500 μl.
h) The efficacy of lipase activity is determined by measuring the time dependent increase in free fatty acids.

### EXAMPLE 4

### Removal of Carotenoids by Treatment in the Organic Solvent Subsequent to Extraction by an Oxidizing Agent (Solvent-Phase Bleaching)

In this experiment samples are treated as described as in Experiment 2. However, at step O the organic solvent (e.g. n-hexane or iso-octane) is saturated (at 20° C.) with peroxide (about 13 mg/ml). Alternatively, this experiment could also be performed using sodium hypochloride.

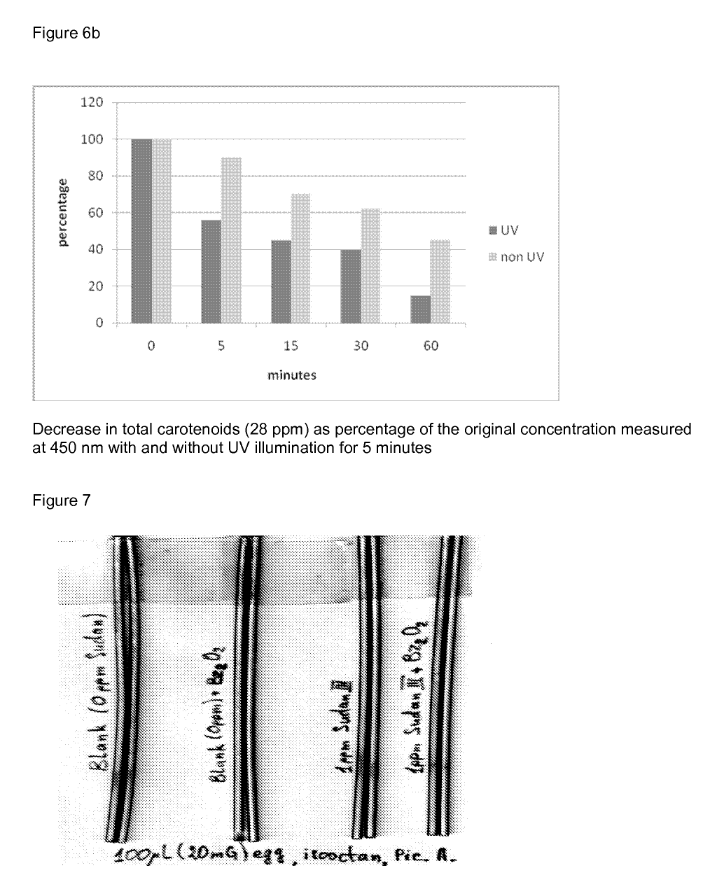

To determine the oxidation capacity the decrease of carotenoids and the stability of carotenoids is determined by HPLC (FIG. 6).

### EXAMPLE 5

### Enhancement of the Removal of Carotenoids by the Application of UV Light to the Organic Solvent Subsequent to Extraction During Oxidation (Enhanced Solvent-Bleaching

In this experiment egg yolk samples (1 g) are extracted into e mixture of alcohols (ethanol and isopropanol (1:2) and n-hexane (ratio of 2:1, 2 ml). The organic supernatant after extraction of carotenoids into the supernantant is removed and the organic solvent (e.g. n-hexane or iso-octane) is saturated (at 20° C.) with peroxide (about 13 mg/ml). Alternatively, this experiment could also be performed using sodium hypochloride.

The organic extract is exposed to UV-light (295 nm) for a period of time as indicated. The decrease of carotenoids are determined spectroscopically at 450 nm.

The results in comparison to degradation time without UV enhancement are depicted in FIG. 6b.

### EXAMPLE 6

### Removal of Carotenoids by the Inclusion of Peroxide on the Column Material (Column-Phase Bleaching)

In this experiment samples were treated as in Experiment 4. However, the oxidizing chemical was added to the column material. In this case carotenoids are destroyed during the separation on the column material (FIG. 7).

The column material is prepared by impregnation of the sorbent with an n-hexane solution of benzyl peroxide. The solution is saturated at 20° C. This impregnation can either be done before filling of capillaries or thereafter. In both cases chromatographic material is vacuum-dried.

### EXAMPLE 7

### Removal of Carotenoids by the Application of Peroxide on the TLC Plate After Carotenoids Separation (Post-Run Bleaching)

In this experiment samples were treated as in Experiment 4. However, the oxidizing chemical has been added to the TLC plate by spraying on after the separation of carotenoids.

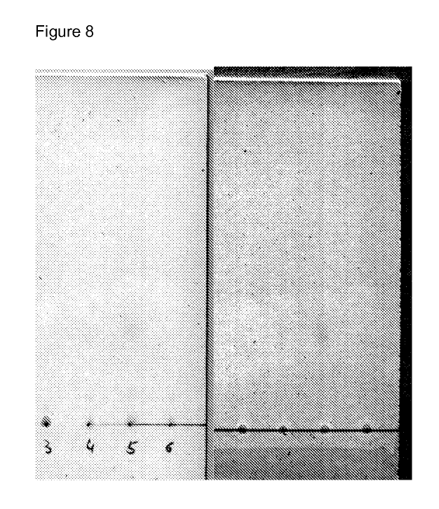

Carotenoids and sudans extracted from egg yolk as described in the previous experiments were applied for separation and concentration on TLC plates. After the TLC run plates were treated with an organic peroxide solution. For this purpose the solution was sprayed onto the plate (FIG. 8).

1. A method for the extraction of lipophilic substances such as natural or synthetic (artificial) fat-soluble dyes from lipid rich biological material, which can comprises a pre-treatment step which acts to make the component more readily available to the extraction and a subsequent extraction step in which the material substances are extracted into an organic solvent which, as a result of the addition of the aqueous sample, divides the material substances into two phases and the components can be detected in the organic solvent phase, wherein prior to final detection oxidative sensible ingredients, such as carotenoids, are destroyed via oxidation.

2. The method as claimed in claim 1, wherein in the pre-treatment step the sample is treated with at least one enzyme in order to remove lipids.

3. The method as claimed in claim 1, wherein the synthetic dyes are azo compounds.

4. The method as claimed in claim 1, wherein the biological materials used are foods or feeds obtained from plants or animals which are rich in lipids, such as egg, butter, fatty milk, cheese, sausages, oils or spices and mixtures of spices.

5. The method as claimed in claim 1, wherein a specific dilution step acts as pre-treatment, which specific dilution step if appropriate, i.e. especially in the case of solid biological materials, is additionally combined with a disruption step.

6. The method as claimed in claim 1, which comprises a pretreatment with certain salt solutions or buffer solutions, in particular urea solutions, of differing concentration.

7. The method according as claimed in claim 1, wherein the sample of the biological material is treated with at least one lipase for enzymatic digestion of lipids, wherein a lipase means a carboxylic ester hydrolase EC 3.1.1.-, which includes activities such as EC 3.1.1.3 triacylglycerol lipase, EC 3.1.1.4 phospholipase A1, EC 3.1.1.5 lysophospholipase, EC 3.1.1.26 galactolipase, EC 3.1.1.32 phospholipase A1, EC 3.1.1.73 feruloyl esterase.

8. The method as claimed in claim 1, wherein, for the extraction, as organic solvent, use is made of polar protic solvents.

9. The method as claimed in claim 8, wherein the polar protic solvents are selected from the group consisting of of methanol, ethanol, 1-propanol, 2-propanol (isopropanol), butanol, pentanol, hexanol, DMSO and mixtures thereof.

10. The method as claimed claim 1, wherein the extraction of carotenoids and sudan is enhanced by a polar apotic solvent.

11. The method as claimed in claim 10 wherein the polar apotic solvent is DMSO.

12. The method as claimed in claim 1, wherein prior to final detection the extracted components are enriched by means of a chromatographic method and accompanying substances such as oxidative sensible ingredients, such as carotenoids, which interfere with the final analysis, are destroyed by treatment with an oxidizer.

13. The method as claimed in claim 10, wherein the oxidizer is a peroxy compound, preferably an inorganic peroxide, such as H₂O₂, K₂S₂O₈ or an organic peroxide such as benzoyl peroxide.

14. The method as claimed in claim 1, where the oxidative destruction of carotenoids is enhanced by UV light.

15. The method as claimed in claim 1, wherein the extracted substances are analyzed spectrometrically, in particular colorimetrically, preferably fluorimetrically.

16. The use of the method as claimed in claim 1, for the detection of dyes in foods and feeds, preferably in in eggs or egg-containing products.

17. An analytical unit for carrying out the method as claimed in claim 1, consisting of a pretreatment kit and an extraction kit, wherein both kits contain one each of a solvent and/or solvent mixture of the above-defined type which is dependent on the biological material and the substance to be analyzed.
